(19) United States
(12) Patent Application Publication
(10) Pub. No.: US 2026/0064959 A1
(43) Pub. Date: Mar. 5, 2026

(54) AI-Enhanced System and Method for Generating Resumes Based on Job Descriptions

(71) Applicant: Syed Shahab Ahmed, Morton Grove, IL (US)

(72) Inventor: Syed Shahab Ahmed, Morton Grove, IL (US)

(21) Appl. No.: 19/318,104

(22) Filed: Sep. 3, 2025

Related U.S. Application Data
(60) Provisional application No. 63/691,252, filed on Sep. 5, 2024.

(51) Int. Cl. G06F 40/186; G06F 40/205; G06F 40/284; G06F 40/58; G06Q 10/1053

(52) U.S. Cl. CPC G06F 40/186; G06F 40/205; G06F 40/284; G06F 40/58; G06Q 10/1053

(57) ABSTRACT

Systems and methods for automatically generating job-specific resumes from a job description or an uploaded resume are provided. The system accepts a job posting link, pasted text, or an uploaded file. It parses the content with natural language processing to extract skills, qualifications, titles, certifications, and context such as seniority, location, and industry. The system selects a template from a region-aware library and assembles a resume that aligns summary, skills, experience, and education. It evaluates applicant-tracking-system compliance, keyword coverage, and readability. When a resume is provided, the system rewrites portions to improve alignment while preserving verifiable facts. It can localize content into multiple languages. A user interface allows review and editing and exports to document or structured formats and to recruitment services. The approach reduces preparation time and increases the likelihood of passing automated screening.

### CROSS REFERENCE TO RELATED APPLICATIONS

This application claims the benefit, under 35 U.S.C. § 119(e), of U.S. Provisional Application No. 63/691,252, filed Sep. 5, 2024, under 35 U.S.C. § 111(b), the entire contents of which are incorporated by reference.

### BRIEF DESCRIPTION OF THE DRAWINGS

FIG. 1. System architecture with Job Description Input (101), AI Keyword Extraction Engine (102), Context/Template Generation (103), Resume Output Interface (104), optional Uploaded Resume (105), and Evaluation module (106).

FIG. 2. Input options and validation flow: receive job description via URL/paste/file (202), optional resume upload (204), validation (203), and transition to extraction (205).

FIG. 3. Natural language processing pipeline: parsing/tokenization (301), NER/dependency (302), keyword extraction (303), context analysis (304), prioritization/scoring (305), and keyword list output (306).

FIG. 4. Workflow branching: decision on existing resume (402) leading to generate a new resume (403) or refine an existing resume (404), followed by ATS/readability checks (405).

FIG. 5. Resume Output Interface with one-click style picker panel (501), resume preview area (502), theme tiles (503), save (504), download (505), and apply style control (506).

FIG. 5A. Post-generation editing workflow: start (5A01), display for editing (5A02), select style and apply (5A03), evaluate ATS constraints (5A04), save and finalize (5A05), and download or submit (5A06).

FIG. 6. Deployment diagram with User Interface (601), Backend API (602), Extraction Engine (603), Template/Style Service (604), Evaluation (605), Integration Connectors (606), Database (607), File Storage (608), and Monitoring/Security (609).

### STATEMENT REGARDING FEDERALLY SPONSORED RESEARCH OR DEVELOPMENT

(Not applicable)

### FIELD OF THE INVENTION

This invention relates to Artificial Intelligence (AI)-enhanced systems and methods for resume generation, more specifically to a system and method that automatically creates resumes tailored to job descriptions by using AI algorithms to extract relevant keywords and optimize them for Applicant Tracking Systems (ATS), including an option for users to upload their existing resumes for AI-based enhancement.

### DESCRIPTION OF THE RELATED ART

The increasing reliance on ATS systems by employers requires job applicants to tailor their resumes to specific job descriptions. However, traditional resume creation tools are often manual, time-consuming, and ineffective in terms of matching the right keywords to pass ATS filters. AI-based tools, which leverage advanced algorithms, provide a solution by automating the extraction and matching of job-related keywords, skills, and qualifications. This application takes advantage of AI technology to efficiently analyze job descriptions, refine uploaded resumes, and create optimized templates that increase applicants' chances of success.

### SUMMARY OF THE INVENTION

The present invention provides an AI-powered system and method for generating optimized resumes based on job descriptions. AI algorithms are employed to extract relevant keywords, skills, and qualifications from a job description and apply them to a newly generated or refined resume. Users can input job descriptions via URL, text input, or by uploading their existing resume. The AI models ensure the resulting resume is optimized for ATS systems, focusing on key factors such as readability, keyword density, and industry relevance.

### DETAILED DESCRIPTION

AI technology in this system enables more intelligent parsing and extraction of job-specific keywords, as well as the application of context-aware resume generation, ensuring that the resume is customized not just to the job but also to the industry norms and job level (e.g., entry-level, mid-level, executive).

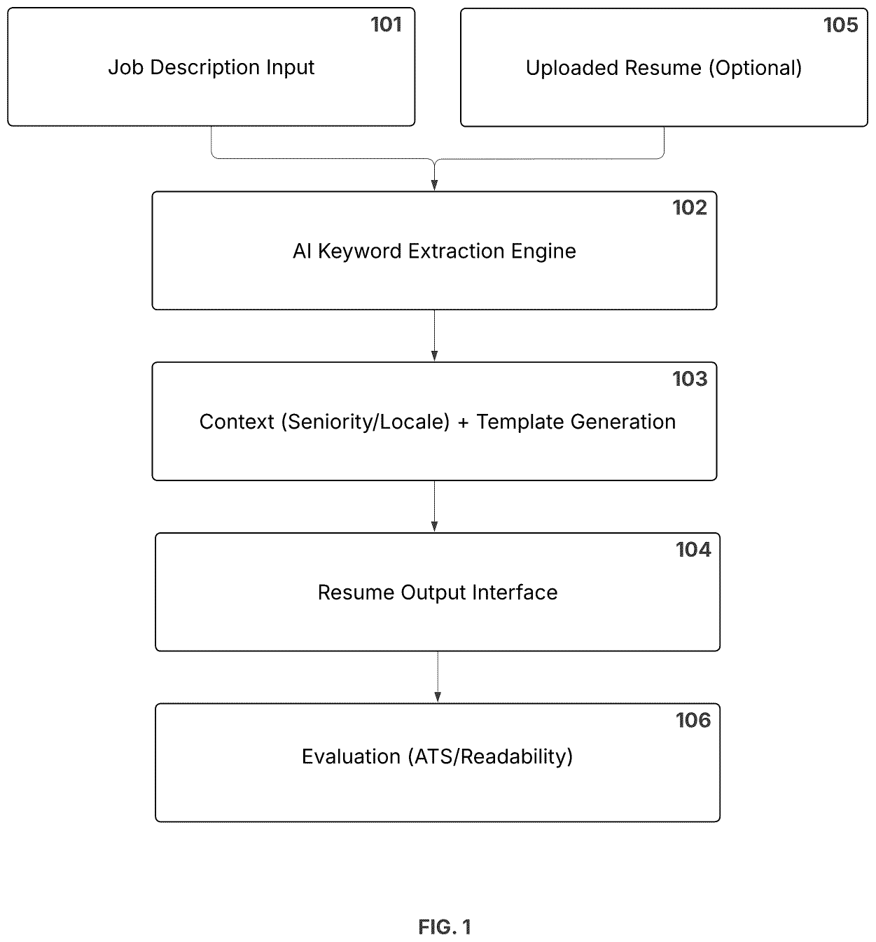

FIG. 1: Diagram of the system architecture showing the interaction between the Job Description Input Module, AI Keyword Extraction Engine, Resume Template Generation Module, and the User Interface.

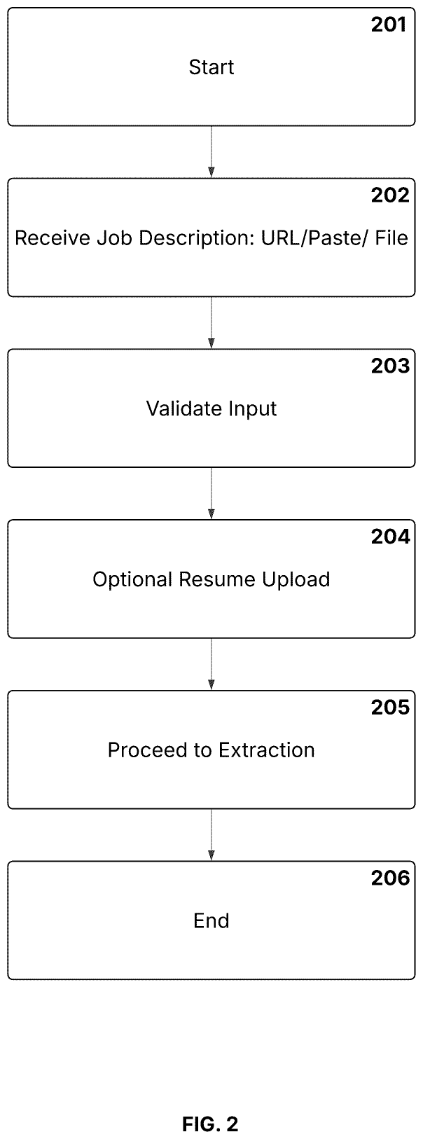

FIG. 2: Flowchart illustrating the process flow for receiving job description input via URL, text input, or resume upload, and how the system processes this information.

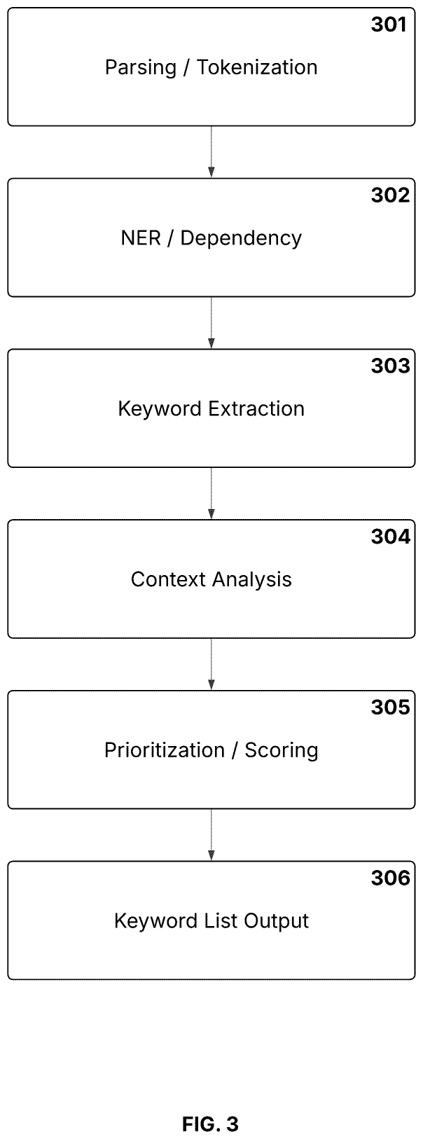

FIG. 3: Diagram of the AI Keyword Extraction Engine, depicting how the engine uses Natural Language Processing (NLP) and machine learning techniques to extract and prioritize relevant keywords.

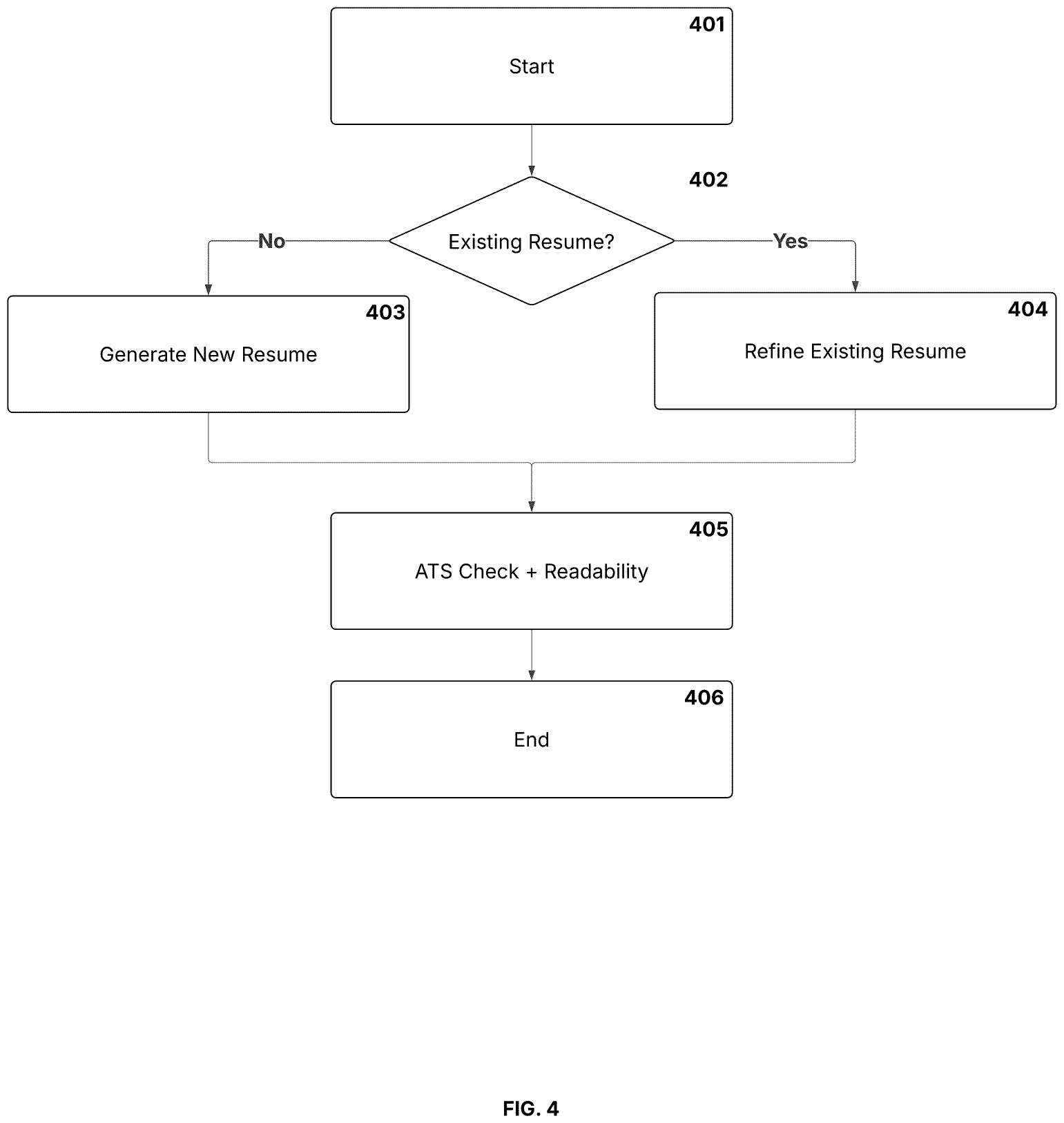

FIG. 4: Example of a resume generated using the system, showing the inclusion of key terms extracted from the job description and how they are highlighted in the resume sections such as Skills, Experience, and Education.

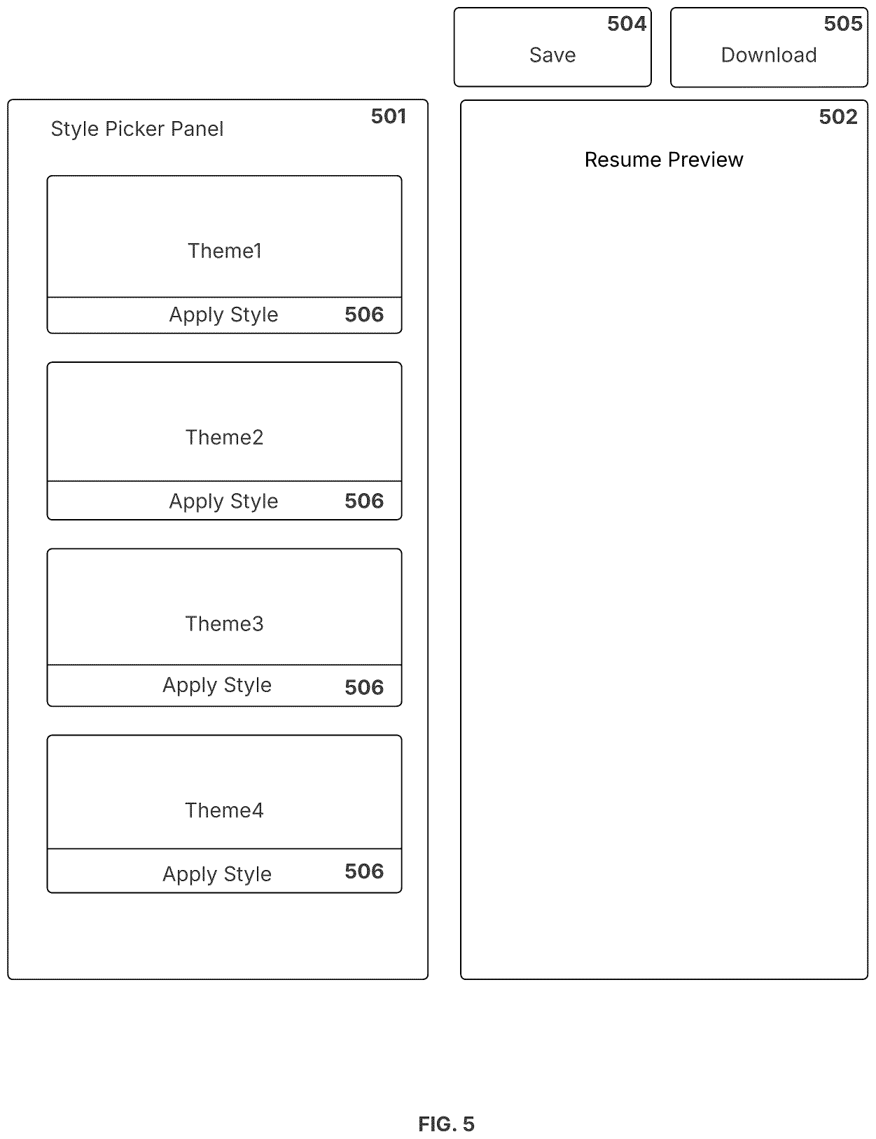

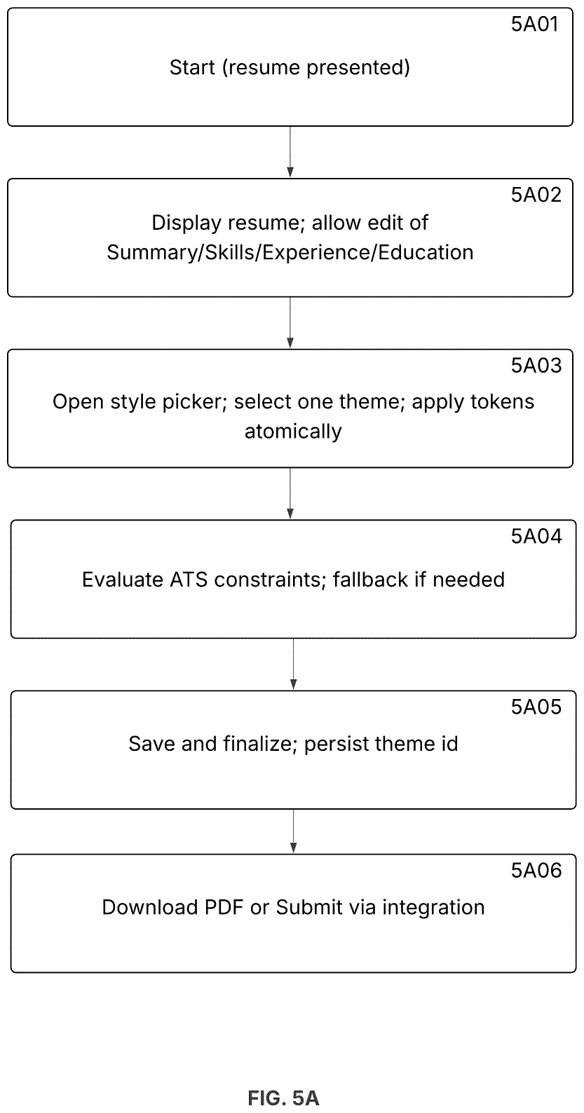

FIG. 5: User Interface mockup illustrating the options for inputting job descriptions, uploading resumes, and previewing or editing the AI-enhanced resume.

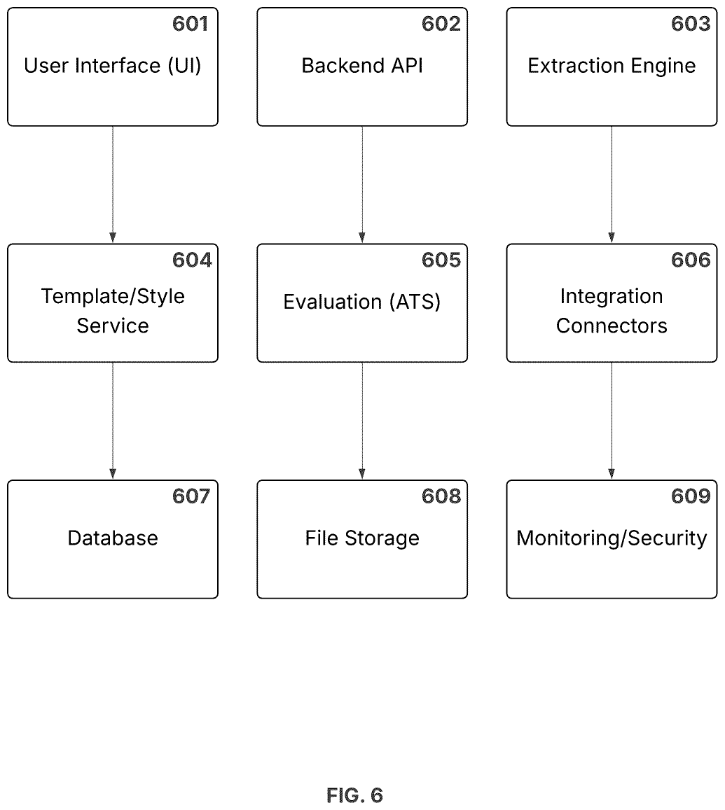

FIG. 6: Cloud-based architecture of the system, showing how components interact with the AWS cloud storage, database, and file system for resume generation, storage, and security.

The present invention relates to an AI-enhanced system and method for generating customized resumes based on job descriptions. The system utilizes artificial intelligence (AI) and machine learning algorithms, including natural language processing (NLP), to extract relevant keywords, skills, and job requirements from job descriptions and match them with existing resumes or create new ones. The system is divided into four key modules, as outlined in FIG. 1, which will be explained in detail below.

### 8.1 Key Modules

### Step 101: Job Description Input Module

At Step 101, the system begins by accepting the job description through the Job Description Input Module, which offers three distinct input methods:

URL Input: The user provides a URL linking directly to a job posting. The system retrieves and processes the job description content from this URL.

Text Input: Alternatively, users can input the job description as raw text. This can be a simple copy-and-paste of job requirements or manually typed content.

Resume Upload: The system also allows users to upload an existing resume. This uploaded resume is cross-referenced with the job description, and the system refines and enhances the resume to align with the specific requirements of the job posting.

The flexibility of the Job Description Input Module ensures that the system can handle multiple formats, offering a user-friendly interface that supports both text and document uploads.

### Step 102: AI Keyword Extraction Engine

In Step 102, the AI Keyword Extraction Engine analyzes the job description using advanced AI technologies. This engine consists of two primary components:

Natural Language Processing (NLP): The system employs NLP to break down and understand the job description, extracting key phrases, skills, qualifications, and job-specific requirements. NLP ensures that the system can identify and categorize both hard and soft skills, as well as understand the job description in context.

Machine Learning: The AI is further enhanced through machine learning algorithms that have been trained on large datasets of job descriptions and resumes. The system learns to identify and prioritize keywords based on job roles, industries, and seniority levels. It also dynamically adapts to new job market trends by learning from new job postings and user feedback.

Through this dual process, the AI Keyword Extraction Engine captures both explicit requirements (such as required certifications or years of experience) and implicit expectations (such as industry jargon or preferred skills), ensuring a comprehensive keyword extraction from the job description.

### Step 103: Resume Template Generation Module

At Step 103, the system proceeds to the Resume Template Generation Module, which generates a new resume or refines an existing resume based on the extracted keywords from Step 102. This module operates in two distinct modes:

Create Resume: If the user has not uploaded an existing resume, the system generates a new resume template from scratch. The extracted keywords and skills are organized into appropriate sections (e.g., work experience, education, skills) to form a professional resume. The system ensures that the formatting follows industry standards and is ATS-friendly.

Refine Resume: For users who have uploaded a resume, the system refines the document by incorporating the keywords and enhancing specific sections. It optimizes the resume for ATS systems by reordering content, inserting critical keywords, and adjusting formatting to improve compatibility with automated resume screening systems.

The Resume Template Generation Module ensures that the final resume is highly customized to the job description, improving the applicant's chances of passing ATS filters and gaining the attention of recruiters.

### Step 104: Resume Output Interface

At Step 104, the system presents the final product through the Resume Output Interface, which offers several options for interacting with the generated or refined resume:

Download: Users can download the optimized resume in popular formats such as PDF or Word, making it easy to store and submit to potential employers.

Edit: The system provides an option to manually edit the generated or refined resume before submitting it. This allows users to make last-minute adjustments or add personal touches.

Submit: Integrated with job application platforms, the system also allows users to submit their optimized resumes directly to job listings or employer portals from within the interface.

The Resume Output Interface gives users complete control over their resumes, enabling them to choose the method that best fits their needs, whether it be downloading for personal use or submitting the resume directly to job postings.

### 8.1.1 Job Description Input Module

The Job Description Input Module, depicted in FIG. 2, provides three options for users to input job descriptions: via URL input, text input, or by uploading an existing resume. Each of these paths converges into a processing stage where the job description or resume data is prepared for further keyword extraction and analysis. The detailed steps for the Job Description Input Module are outlined below.

### Step 1: Start

The process begins when the user initiates the resume generation system. This is the initial stage where the system is activated and ready to receive input from the user.

### Step 2: Display Input Options

At this point, the system prompts the user to choose one of three methods to provide the job description. The user can select between inputting a URL, manually entering text, or uploading an existing resume. The system branches off into different paths based on the user's selection and proceeds accordingly.

### Step 3: URL Input Path

If the user selects the URL input option, the system will follow a path where it prompts the user to provide a URL linking to a job posting. The user enters the URL, and the system verifies whether the URL is valid and accessible. If the URL is invalid or inaccessible, the system will notify the user and request that a valid URL be entered. Once the URL is validated, the system scrapes the job description from the webpage and retrieves the necessary data. This data is then processed to extract key information for further analysis.

### Step 4: Text Input Path

If the user selects the text input option, the system allows the user to manually enter the job description, either by typing or copying and pasting the content into the input field. After the job description is entered, the system validates the input by checking whether it contains sufficient information, such as job-related terms or a minimum character count. If the input is found to be invalid, the system will prompt the user to re-enter a valid job description. Once the text is validated, the system processes the job description, extracting important components such as skills, qualifications, and responsibilities.

### Step 5: Resume Upload Path

If the user selects the option to upload a resume, the system follows the resume upload path. In this step, the user uploads an existing resume file in supported formats such as PDF or DOCX. The system validates the uploaded file to ensure that it is readable and contains sufficient information. If the file is not valid, the user is asked to upload a valid resume file. After validation, the system extracts relevant information from the resume, such as work experience, skills, and education, to cross-reference with the job description.

### Step 6: Process Job Description

After the job description or resume is provided through any of the available input methods, the system converges to this stage where it processes the job description or resume content for further analysis. The extracted data will be used for keyword extraction, contextual matching, and the subsequent stages of resume generation and refinement.

### Step 7: End

The process concludes once the job description or resume has been successfully processed. The system is now ready for the next phase of operation, which involves keyword extraction, matching, and refining the resume based on the provided job description.

### 8.1.2 AI Keyword Extraction Engine

The AI Keyword Extraction Engine, depicted in FIG. 3, is designed to analyze job descriptions or resume content to identify, prioritize, and contextualize relevant keywords and skills. These keywords are then used to generate or refine a resume, ensuring it aligns with the job's requirements. The engine utilizes Natural Language Processing (NLP) and machine learning techniques throughout the process. Below are the steps of the process:

### Step 1: Start

The process begins when the AI Keyword Extraction Engine is activated after receiving the processed job description or resume data from the Job Description Input Module.

### Step 2: Parse Job Description Using NLP

At this stage, the system uses NLP to parse the job description or resume text. The input is broken down into smaller components, such as individual words, phrases, and sections. Parsing the content structures it in a way that enables further analysis for meaning and relevance, making it easier for the system to extract useful information.

### Step 3: Extract Keywords and Skills

Once the job description or resume has been parsed, the system identifies relevant keywords and skills. This includes both hard skills (e.g., “data analysis,” “Java programming”) and soft skills (e.g., “communication,” “leadership”). The system also extracts job-specific qualifications, such as required certifications, educational backgrounds, and professional experience.

### Step 4: Prioritize Keywords

After the keywords and skills have been extracted, the system prioritizes them based on their relevance to the job posting. The AI evaluates the job description to determine which keywords are most important, giving higher priority to essential skills, qualifications, and job roles. The system uses machine learning to analyze industry standards, job role requirements, and keyword frequency to decide which terms should be emphasized in the resume.

### Step 5: Contextual Analysis

The system then performs contextual analysis to ensure that the extracted keywords are relevant and correctly matched to the job description. It examines how keywords relate to each other within the job description. For example, if the job mentions “team leadership,” the system determines if it is a core requirement or a preferred skill based on the surrounding text and context.

### Step 6: Generate Keyword List

Once the system has completed the extraction and contextual analysis, it generates a list of keywords and skills that are crucial for the job description. This list is compiled in a structured format, which will be used in the resume refinement or generation process. The system ensures that the keywords align with the job posting's specific requirements, making the resume more likely to pass through Applicant Tracking Systems (ATS) and attract the attention of recruiters.

### Step 7: End

The process concludes when the keyword list is generated. This list will now be used for the next stage, which involves applying these keywords in the resume generation or refinement process, ensuring the resume is optimized for the job description provided.

### 8.1.3 Resume Template Generation Module

The Resume Template Generation Module, depicted in FIG. 4, is responsible for creating new resumes or refining existing ones based on the keywords extracted from the job description. This module uses the list of prioritized and contextually analyzed keywords generated by the AI Keyword Extraction Engine to ensure that the resume aligns with the job posting's requirements. The module tailors each section of the resume (e.g., skills, experience, education) to highlight relevant qualifications. Below are the steps of the process:

### Step 1: Start

The process begins when the system receives the keyword list generated by the AI Keyword Extraction Engine. This list contains the relevant skills, qualifications, and key terms necessary for resume generation or refinement.

### Step 2: Check for Existing Resume

At this stage, the system checks whether the user has uploaded an existing resume. This step determines whether the system will generate a new resume from scratch or refine an existing one.

If no resume is uploaded, the system proceeds to generate a new resume.

If an existing resume is provided, the system proceeds to refine it by incorporating the extracted keywords.

### Step 3A: Generate New Resume

If the user has not uploaded a resume, the system generates a new resume from scratch. The system uses the keyword list to fill in the resume's sections, such as the skills, work experience, education, and summary. It ensures that the relevant qualifications and skills extracted from the job description are prominently highlighted in the appropriate sections.

### Step 3B: Refine Existing Resume

If the user has uploaded a resume, the system refines it by integrating the keywords from the job description. This involves revising and enhancing specific sections of the resume to emphasize the extracted skills and qualifications. The system may also adjust the formatting and language of the resume to ensure it is optimized for ATS (Applicant Tracking System) compatibility.

### Step 4: Optimize Resume Formatting

Regardless of whether the system generates a new resume or refines an existing one, it optimizes the resume's format. This includes ensuring proper alignment, font consistency, section headers, and readability. The formatting is adjusted to comply with ATS requirements, ensuring that the resume can be successfully parsed by automated systems used by recruiters.

### Step 5: Customize Resume Sections

The system ensures that each section of the resume is customized according to the job description:

Skills Section: Key skills extracted from the job description are added or highlighted in this section.

Experience Section: The system cross-references the user's work experience with the job description, ensuring that relevant experiences are emphasized.

Education Section: Relevant qualifications or degrees are highlighted based on the requirements of the job posting.

Summary/Objective Section: The system creates or refines a summary that aligns with the job role, using keywords to ensure the resume is tailored to the job description.

### Step 6: Generate Final Resume

Once the resume has been generated or refined and formatted, the system generates the final version of the resume.

### Step 7: End

The process concludes when the final resume is prepared.

### 8.1.4 Resume Output Interface

The Resume Output Interface, depicted in FIG. 5, allows users to interact with the generated or refined resume. After the system completes the resume generation or refinement process, the user is provided with options to download, manually edit, or directly submit the resume. Additionally, the user has the ability to remove any skills or qualifications they do not possess, ensuring that the resume accurately reflects their abilities.

### Step 1: Start

The process begins when the system presents the finalized resume to the user after the resume generation or refinement process has been completed.

### Step 2: Display Resume for Editing

At this stage, the system allows the user to review the generated resume. The user is given an option to edit the resume, allowing them to modify any section, particularly the skills section, where they can remove any skills they do not have. This ensures that the resume reflects the user's true capabilities.

### Step 3: Edit Skills and Content

The user manually edits the resume to remove skills, qualifications, or experiences that they do not possess. The system provides a user-friendly interface to facilitate easy editing of skills, experience, and other sections. The user can:

Remove specific skills from the skills section.

Edit the work experience to make sure it accurately reflects their past positions and responsibilities.

Adjust the summary/objective to better align with their career goals.

### Step 4: Save and Finalize Resume

Once the user has finished editing the resume, they can save the changes. The system finalizes the resume, ensuring that all adjustments are applied, and generates the final version.

### Step 5: Download Resume

The user is provided with the option to download the finalized resume in PDF format. This allows the user to store the resume for personal use or to manually submit it to job postings.

### Step 6: End

The process concludes once the user has either downloaded or submitted their resume. The system is then ready to assist the user with further actions, such as applying for additional jobs or refining the resume for other job descriptions.

### Architecture Diagram

The architecture for the AI-enhanced resume generation system, depicted in FIG. 6, consists of several interconnected components designed to manage user interactions, process job descriptions, generate or refine resumes, and store data securely in the cloud. Below is a breakdown of each component:

### UI Interface (Web/Mobile)

The User Interface (UI) serves as the primary interaction point for users. It allows users to:

Input job descriptions (via URL, text input, or by uploading resumes).

Edit resumes, add or remove skills.

Download or submit their generated resumes.

Register and log in to their accounts.

The UI communicates directly with the Backend API, sending and receiving data to facilitate these interactions.

### Backend API

The Backend API acts as the core processing engine of the system. It handles requests from the UI and communicates with various backend components. Its responsibilities include:

Processing job descriptions for keyword extraction and resume generation.

Handling user authentication and authorization.

Interfacing with the Database and File System to store or retrieve user data and resumes.

Coordinating between the AI systems that extract keywords from job descriptions and refine or create resumes.

### Database (SQL or NoSQL)

The Database stores critical user information such as:

User profiles and login credentials.

Job descriptions and historical job-related data.

Keywords and metadata extracted from job descriptions.

Any user preferences or history related to resume generation.

This ensures the system has quick access to user data and can maintain user sessions across different devices.

### File System for Resumes

The File System is used to store both uploaded resumes and newly generated or refined resumes. It provides a central location for saving files securely, ensuring users can retrieve or download their resumes as needed.

This file system may be part of a larger cloud storage solution integrated with AWS.

### Authentication System (JWT)

The Authentication System manages user login and registration. It secures user access to the platform, enabling features such as:

Secure login and registration.

Managing user sessions.

Role-based access control, ensuring that only authenticated users can access certain functionalities.

This system ensures that user data and generated resumes are protected and accessible only by authorized users.

AWS Cloud (S3 for Storage, EC2/Lambda for Compute, RDS for Database) The AWS Cloud provides scalable infrastructure for storage and computing:

AWS S3 stores resumes and job descriptions, ensuring scalability and durability.

AWS EC2/Lambda offers compute services to handle resume processing, keyword extraction, and other backend functions.

AWS RDS provides managed database storage, ensuring high availability and performance for storing user data and job descriptions.

Using AWS Cloud allows the system to scale efficiently, handling large volumes of users and processing complex job descriptions or resume generation tasks.

### Third-Party API Integrations

Third-Party APIs can be integrated for additional functionality, such as:

Integration with payment gateways (if a subscription model is used).

Integration with the External Login Services

### Monitoring and Security Systems

To ensure the system operates smoothly and securely, Monitoring Systems (e.g., AWS CloudWatch, Elastic Stack) monitor the health of the infrastructure and track performance. Additionally, Security Systems (e.g., SSL/TLS, AWS IAM) ensure that:

All communication between the UI, API, and backend systems is encrypted.

User data, including resumes and credentials, is securely stored and transmitted.

Proper role-based access control and encryption protocols are implemented to maintain data security.

1. A computer implemented method for generating a resume that is tailored to a job description, the method comprising: (a) receiving input that includes at least one of a job description link, job description text, an uploaded resume, or any combination; (b) parsing the job description with natural language processing to extract skills, qualifications, titles, certifications, and job specific requirements; (c) determining context that includes at least one of role seniority, location, language, and industry norms; (d) constructing a resume draft that places extracted elements into predefined sections that include summary, skills, experience, and education while preserving applicant tracking system compliance; (e) when the input includes the uploaded resume, rewriting one or more portions of the uploaded resume to align with the job description; (f) evaluating the resume draft for keyword coverage, formatting constraints, and readability; and (g) providing the resume draft for user review, editing, and export.

2. The method of claim 1, wherein parsing includes tokenization, part of speech tagging, named entity recognition, and transformer based inference.

3. The method of claim 1, wherein determining role seniority is based on the job title, required years of experience, and patterns learned from prior postings.

4. The method of claim 1, wherein evaluating applicant tracking system compliance includes verifying headings, section order, font usage, bullet structure, and absence of incompatible graphics.

5. The method of claim 1, wherein constructing the resume draft selects a template from a library that is specific to a locale or industry.

6. The method of claim 1, wherein providing the resume draft includes generating at least one of a PDF file, a word processing document file, or a structured data file.

7. The method of claim 1, further comprising suggesting quantified bullet points for experience items that reference skills required by the job description.

8. The method of claim 1, wherein rewriting the uploaded resume excludes adding unverified achievements and requires user confirmation before inserting content that is not present in the uploaded resume.

9. The method of claim 1, further comprising translating the resume draft into a target language and adjusting date and number formats for the target locale.

10. The method of claim 1, further comprising exporting data to a recruitment platform application programming interface or to a professional networking site.

11. A system for generating a resume that is tailored to a job description, the system comprising: an input module configured to receive at least one of a job description link, job description text, an uploaded resume, or any combination; an extraction engine configured to apply natural language processing to identify skills, qualifications, titles, certifications, and job specific requirements from the job description; a context module configured to determine at least one of role seniority, location, language, or industry norms; a template generation module configured to assemble a resume draft using a template library that is compliant with applicant tracking systems; a refinement engine configured to rewrite selected portions of an uploaded resume to align with the job description; an evaluation module configured to measure keyword coverage, readability, and formatting constraints; and a user interface configured to present the resume draft for review, editing, and export.

12. The system of claim 11, wherein the extraction engine comprises a transformer based language model that is fine tuned on hiring related corpora.

13. The system of claim 11, wherein the template library contains region aware templates that differ by headings, section order, and typographic rules.

14. The system of claim 11, wherein the evaluation module enforces applicant tracking system constraints that include machine readable headings and avoidance of text embedded in images.

15. The system of claim 11, wherein the user interface provides warnings when skill coverage for the job description is below a threshold.

16. The system of claim 11, further comprising an integration module to connect to external authentication, payment, or recruitment systems.

17. A non transitory computer readable medium that stores instructions that, when executed by one or more processors, cause performance of operations comprising: receiving input that includes at least one of a job description link, job description text, an uploaded resume, or any combination; extracting job requirements using natural language processing; determining role seniority and locale for the job description; assembling a resume draft that is aligned with the job description and complies with applicant tracking system constraints; rewriting an uploaded resume to improve alignment; evaluating keyword coverage and readability; and providing the resume draft for review, editing, and export.

18. The non transitory computer readable medium of claim 17, wherein extracting job requirements comprises named entity recognition and dependency parsing.

19. The non transitory computer readable medium of claim 17, wherein assembling the resume draft includes selecting a template from a library based on locale or industry.

20. The non transitory computer readable medium of claim 17, wherein providing the resume draft includes exporting to a structured data format for integration with a recruitment platform.
